(19) United States
(12) Patent Application Publication
(10) Pub. No.: US 2020/0253252 A1
(43) Pub. Date: Aug. 13, 2020

(54) COMPOSITION FOR MODIFYING MEAT

(71) Applicant: AJINOMOTO CO., INC., Tokyo (JP)

(72) Inventors: Ryusuke KOBA, Kawasaki-shi (JP); Soichiro Kori, Kawasaki-shi (JP)

(73) Assignee: AJINOMOTO CO., INC., Tokyo (JP)

(21) Appl. No.: 16/863,183

(22) Filed: Apr. 30, 2020

Related U.S. Application Data
(63) Continuation of application No. PCT/JP2018/041579, filed on Nov. 9, 2018.

(30) Foreign Application Priority Data
Nov. 9, 2017 (JP) 2017-216795

(51) Int. Cl. A23L 13/40; A23L 29/00

(52) U.S. Cl. CPC A23L 13/48; A23L 29/06; A23L 29/035; A23L 13/42

(57) ABSTRACT

Compositions that contain gluconate and protease at a proportion of 100 to 100,000,000 U of protease per 1 g of gluconic acid can be used to provide a prepared meat product with a juicy and tender meat center even after heating.

### CROSS REFERENCES TO RELATED APPLICATIONS

This application is a continuation of International Patent Application No. PCT/JP2018/041579, filed on Nov. 9, 2018, and claims priority to Japanese Patent Application No. 2017-216795, filed on Nov. 9, 2017, both of which are incorporated herein by reference in their entireties.

### BACKGROUND OF THE INVENTION

### Field of the Invention

The present invention relates to compositions for modifying meat, prepared meat products containing such a composition, and production methods thereof.

### Discussion of the Background

In the meat processing field and meat cooking field, meat is cut and subjected to various treatments. Among them, when a heat treatment such as boiling, baking, frying or the like is applied to meat, it is known that meat loses a juicy feeling and the texture is degraded due to denaturation by heating.

To solve these problems, some attempts have been made. As exemplary use of organic acid salts and the like, a meat treating agent using an alkali metal salt of gluconic acid for improving the quality of boiled meat (see JP-B-4203555, which is incorporated herein by reference in its entirety), a preparation containing gluconate, calcium lactate and an alkali agent for treating marine products or meat (see JP-B-5882792, which is incorporated herein by reference in its entirety), and a processed meat improving agent containing oligosaccharide, a starchy raw material and a soluble salt of an organic acid (see JP-A-2006-67998, which is incorporated herein by reference in its entirety) have been reported. As exemplary use of enzyme, a food quality improver containing a starch degrading enzyme and protease in combination and showing a softening action on meat and the like (see JP-A-7-31396, which is incorporated herein by reference in its entirety), a meat quality and flavor improver containing protease, amylase and the like (see JP-A-5-276899, which is incorporated herein by reference in its entirety), and a production method of a processed meat and the like with improved properties and taste which uses an enzyme having a transglucosylation activity, transglutaminase and the like (see JP-B-5056193, which is incorporated herein by reference in its entirety) have been reported.

### SUMMARY OF THE INVENTION

Accordingly, it is one object of the present invention to suppress denaturation of meat by heating.

It is another object of the present invention to suppress drying of the meat center after heating.

It is another object of the present invention to provide a processed meat product with improved juiciness.

These and other objects, which will become apparent during the following detailed description, have been achieved by the inventors' discovery that heat denaturation by a heat treatment is suppressed and a prepared meat product with superior texture and a juicy and tender meat center can be obtained by bringing the meat in contact with a composition containing gluconate and protease.

That is, the present invention provides the following.

(1) A composition for modifying meat, comprising gluconate and protease.

(2) The composition of (1), wherein the protease is contained at 100 to 100,000,000 U per 1 g of gluconic acid.

(3) The composition of (1) or (2), wherein the gluconate is at least one selected from the group consisting of sodium gluconate, potassium gluconate and calcium gluconate.

(4) A method for producing a prepared meat product, comprising a step of bringing meat in contact with gluconate and protease.

(5-1) The method of (4), wherein the gluconate is comprised such that 0.001 to 5 g of gluconic acid is contacted per 100 g of the meat.

(5-2) The method of (4), wherein the gluconate is comprised such that 0.00001 to 5 g of gluconic acid is contacted per 100 g of the meat.

(6) The method of (4) or (5), wherein 0.1 to 500,000,000 U of the protease is contacted per 100 g of the meat.

(7) A prepared meat product comprising gluconate and protease, wherein the gluconate is comprised such that 0.001 to 5 g of gluconic acid is contained, and 0.1 to 500,000,000 U of the protease is contained, each per 100 g of meat.

(8) A method for modifying meat, comprising a step of bringing the meat in contact with gluconate and protease.

### Effect of the Invention

According to the present invention, a prepared meat product that does not lose umami and juiciness of the meat even after heating and can afford a juicy and tender texture up to the meat center can be provided.

According to the present invention, a prepared meat product with a good taste and suppressed over-decomposition of meat can be provided.

### DETAILED DESCRIPTION OF THE PREFERRED EMBODIMENTS

The present invention relates to a composition containing gluconate and protease for modifying meat (hereinafter sometimes to be abbreviated as the composition of the present invention).

The gluconate to be used in the present invention is, for example, a pharmacologically acceptable salt of gluconic acid. Examples thereof include alkali metals such as lithium, sodium, potassium and the like; alkaline earth metals such as calcium, magnesium and the like; ammonium; and salts with basic organic substance and the like and salts with minerals such as iron, copper, manganese and the like. Among these, from the aspect of salt generally used for foods, salts with sodium, potassium and calcium are preferable, and a salt with sodium is more preferable.

Only one kind of gluconate or two or more kinds thereof may be used in combination, and a commercially available one or one obtained by a method known per se may be used.

Furthermore, the gluconate may be any of a hydrate, a non-hydrate, a non-solvate and a solvate.

The protease to be used in the present invention has an activity to catalyze hydrolysis of a peptide bond in protein, and is a protease capable of decomposing meat protein.

The origin of protease is not particularly limited and, for example, one derived from plant such as papaya, pineapple and the like, one derived from mammal or fish such as pancreas extract and the like, one derived from microorganism such as mold and the like, and the like can be mentioned.

Only one kind of these proteases or two or more kinds thereof may be used in combination, and one obtained by a method known per se or a commercially available one may be used.

Particularly, papain, bromelain, actinidin and the like are preferable, and papain is more preferable, because the tenderness of the meat center and a juicy feeling-improving effect become high when combined with gluconate.

In the present invention, the form of meat is not particularly limited and, for example, block meat, sliced meat (thinned meat, thickly sliced meat, thinly sliced meat), small sliced meat, minced meat, sliced fish and the like can be mentioned, and block meat, sliced meat (thin sliced meat, thickly sliced meat, thinly sliced meat), and small sliced meat are preferable. The size and shape of the meat are not particularly limited.

The meat kind is not particularly limited and, for example, meat and poultry such as pig, cow, chicken, sheep, goat, horse, camel, bear, rabbit, wild duck, pigeon, duck, quail, alpaca, and the like; fish such as salmon, salmon, cod, sea bream, tuna, swordfish, bonito, sardines, and the like; and the like can be mentioned. Particularly, since the effect of the present invention is more easily afforded, meat and poultry such as pig, cow, chicken, sheep, goat, horse, rabbit, wild duck and the like are preferable, and pig, cow, and chicken are more preferable.

In the present invention, the “meat modification” refers to improving or enhancing the quality of meat after heat cooking, such as texture, taste, flavor and the like.

The texture is a feeling such as chewiness and feeling on the tongue when food is put into the mouth. In the case of meat products, it refers to a juicy feeling, tenderness, elasticity, crispness, fibrousness, smoothness, dryness, and the like.

The proportion of gluconate and protease contained in the composition of the present invention is, when converted to gluconic acid, such that the enzyme activity of protease is generally 100 to 100,000,000 U, preferably 500 to 50,000,000 U, more preferably 2,000 to 20,000,000 U, per 1 g of gluconic acid, from the aspects of quality such as texture, taste, flavor and the like.

As for the enzyme activity of protease in the present specification, the amount of the enzyme that achieves an increase in a color developed substance with a Folin reagent that corresponds to 1 μg of tyrosine using casein as a substrate per one minute at 37±0.5° C. is defined as 1 unit (1 U).

The composition of the present invention may be in a form concurrently containing protease and gluconate, or in the form of a kit for combining, immediately before use, the separately-prepared components. From the aspects of workability and convenience, the form of concurrently containing them is preferable.

The composition of the present invention may contain other components as long as the effect of the present invention is not impaired. The composition of the present invention may be constituted as a seasoning.

Such “other component” is not particularly limited as long as it can be ingested orally. As the “other component”, those used by blending with seasonings, foods, or drinks can be utilized.

Specific examples of the “other component” include excipients such as dextrin, lactose and the like; seasonings such as sodium chloride, sodium glutamate, sodium inosinate, yeast extract, meat extract, seafood extract, vegetable extract, protein hydrolysate, protein partial hydrolysate and the like; proteins such as plant protein, gluten, egg white, gelatin, casein and the like; emulsifiers such as (poly)glycerol fatty acid ester, sorbitan fatty acid ester, sucrose fatty acid ester, propylene glycol ester of fatty acid, calcium stearoyl lactate, various phosphates, lecithin (soybean and egg-yolk), saponin and the like; chelating agents such as citrate, polymerized phosphate and the like; reducing agents such as glutathione, cysteine and the like; lye water; dye; acidulants such as vinegar powder, high acidic vinegar powder, citric acid, succinic acid, lactic acid, malic acid, tartaric acid, gluconic acid, phosphoric acid, citrus juice and the like; flavors such as peppermint flavor, orange flavor, sesame flavor, ginger flavor, garlic flavor and the like; and the like. These components may be used alone, or in any combination.

Examples of the form of the composition of the present invention include solids such as powder and the like, liquid, paste and the like, and any form may be employed as long as addition to meat by uniform penetration or mixing is possible, and the effect of the present invention can be afforded.

The “powder” refers to an aggregate of particles, and is a concept that includes granules and the like in addition to granules, micro granules, and fine granules and the like, and also includes particle powders and the like obtained by mixing them.

When the composition of the present invention is a solid (powder), the composition may contain only gluconate and protease, or may contain the above-mentioned other components. The content of gluconate in the composition is, typically 0.05 to 99.9 wt %, preferably 0.25 to 50 wt %, more preferably 1 to 20 wt %, based on the gluconic acid, to the total amount of the composition from the aspects of qualities such as texture, taste, flavor and the like. The enzyme activity of protease in the composition is typically 100 to 100,000,000 U, preferably 500 to 50,000,000 U, more preferably 2,000 to 20,000,000 U, per 1 g of gluconic acid.

When the composition of the present invention is a liquid, a solvent such as water and the like and, where necessary, the above-mentioned other components may be added. The content of gluconate in the composition is typically 0.05 to 99.9 wt %, preferably 0.25 to 50 wt %, more preferably 1 to 20 wt %, based on the gluconic acid, to the total amount of the composition from the aspects of qualities such as texture, taste, flavor and the like. The enzyme activity of protease in the composition is typically 100 to 100,000,000 U, preferably 500 to 50,000,000 U, more preferably 2,000 to 20,000,000 U, per 1 g of gluconic acid.

When the composition of the present invention is a paste, an additive to provide a paste (state with flowability and high viscosity) conventionally used for meat processing and, where necessary, the above-mentioned other components may be added. The content of gluconate in the composition is typically 0.05 to 99.9 wt %, preferably 0.25 to 50 wt %, more preferably 1 to 20 wt %, based on the gluconic acid, to the total amount of the composition from the aspects of qualities such as texture, taste, flavor and the like. The enzyme activity of protease in the composition is typically 100 to 100,000,000 U, preferably 500 to 50,000,000 U, more preferably 2,000 to 20,000,000 U, per 1 g of gluconic acid.

The composition of the present invention can improve or enhance meat texture after heat cooking by processing the meat as follows:

when the composition is a powder, it is added to meat at a proportion of typically not less than 0.00001 g, preferably not less than 0.0001 g, more preferably not less than 0.001 g, per 100 g of the meat,
when the composition is a liquid, meat is immersed therein at a proportion of typically not less than 10 g, preferably not less than 20 g, more preferably not less than 30 g, per 100 g of the meat,
when the composition is a paste, it is applied to meat at a proportion of typically not less than 0.0001 g, preferably not less than 0.001 g, more preferably not less than 0.01 g, per 100 g of the meat.

The composition of the present invention can be produced by general production techniques for foods and the like and in accordance with the aforementioned components, amounts to be added and forms.

The composition of the present invention may be added at any stage of the production step of a prepared meat product. It is preferable to directly add the composition to raw meat since the effect of the present invention can be obtained easily.

The composition of the present invention may be added only once to meat, or may be added in two or more portions.

The composition of the present invention can be used as a meat modifier when cooking meat by blending with (1) powdered base material such as wheat flour, powder seasoning and the like; (2) liquid seasoning such as broth, sauce and the like; (3) liquid edible fats and oil for cooking such as soybean oil, corn oil and the like; (4) plastic oil such as refined lard, shortening and the like, (5) W/O emulsion composition such as margarine and the like, (6) O/W emulsion composition and the like.

The present invention also contains a production method of a prepared meat product including a step of bringing meat in contact with gluconate and protease (hereinafter sometimes to be abbreviated as “the method of the present invention”).

In the present invention, the “prepared meat product” means a food before heating, a material food to be subjected to a cooking treatment such as heating and the like, and a food that have been cooked by heating and the like.

In the method of the present invention, a method for bringing meat in contact with gluconate and protease is not particularly limited and attaching gluconate and protease to a meat surface, immersing meat therein, coating meat therewith, kneading them into meat (minced meat), introducing them into the inside of meat using an injector, tumbling meat therewith, introducing them during tenderizing and the like can be mentioned.

Examples of the method for attaching to a meat surface include a method of sprinkling on the surface of meat using fine mesh such as colander, sieve and the like, a method of sprinkling directly on the whole meat surface, a method of shaking the composition and meat together in a plastic bag, a method of spreading the composition on a thin tray such as a vat and the like and bringing meat in contact with the composition and the like.

To achieve uniform contact with the meat, gluconate and protease may be mixed in advance with a trituration (subsidiary material) and the like and diluted before use. Examples of the trituration include dextrin, sodium chloride, sodium glutamate and the like. The mixing ratio of gluconate and protease and the trituration can be appropriately adjusted according to the amounts of gluconate and protease to be added.

Examples of the method for immersing meat include a method of preparing a liquid by dissolving or dispersing gluconate and protease in a solution at a salt concentration used for conventional meat processing, and immersing the meat therein and the like. Examples of the solution include brine, phosphate solution such as sodium polyphosphate and the like, alkaline solution such as sodium carbonate and the like, starch solution such as potato starch and the like, pickle such as sugar, vinegar, soy sauce and the like, and the like.

Examples of the method for coating meat include a method of mixing gluconate and protease with an additive for forming a paste (state with flowability and high viscosity) used for conventional meat processing to prepare a paste and applying same to meat and the like. Examples of the additive include water, emulsifier, starch, polysaccharide thickener, mucopolysaccharide, mannan, fats and oils, fatty acid, glycerol, sugar alcohol and the like.

Among these, a method for immersing meat, kneading into meat (minced meat), or introducing into the inside of meat using injector is preferable, from the aspects of ease of obtaining effects, workability and convenience.

The amount of gluconate to be contacted (added) varies depending on the form of meat. It is typically 0.001 to 5 g, preferably 0.005 to 2.5 g, more preferably 0.01 to 1 g, based on gluconic acid, per 100 g of the meat. When it is within this range, a juicy meat center and good texture after cooking can be maintained.

The amount of gluconate to be contacted (added) varies depending on the form of meat. It is typically 0.00001 to 5 g, preferably 0.0001 to 2.5 g, more preferably 0.0005 to 1 g, based on gluconic acid, per 100 g of the meat. When it is within this range, a juicy meat center and good texture after cooking can be maintained.

The amount of protease to be contacted (added) varies depending on the form of meat. It is an amount corresponding to the enzyme activity of typically 0.1 to 500,000,000 U, preferably 0.5 to 250,000,000 U, more preferably 1 to 100,000,000 U. When it is within this range, a juicy meat center and good texture after cooking can be maintained.

The proportion of gluconate and protease to be contacted in the method of the present invention is typically 100 to 100,000,000 U, preferably 500 to 50,000,000 U, more preferably 2,000 to 20,000,000 U, of protease per 1 g of gluconic acid.

The time during which the composition of the present invention is contacted with meat (time after addition of the composition of the present invention to meat and before being subjected to cooking, packaging, freezing step, and the like) is not particularly limited as long as gluconate and protease can act on the meat. In view of ease of obtaining effects and handling at meat processing sites, it is typically not less than 30 min, preferably not less than 60 min, more preferably not less than 120 min, further preferably not less than 180 min, particularly preferably not less than 18 hr. While the upper limit is not particularly set, it is typically not more than 72 hr, preferably not more than 20 hr.

The contact temperature (reaction temperature) is not particularly limited as long as the enzyme can maintain activity. From the aspect of reaction efficiency, it is typically 0 to 60° C., preferably 0 to 30° C. When the retention time is not less than 1 hr, from the aspect of food hygiene, it is preferable to keep the meat in a refrigerator.

The pH at the time of contact is not particularly limited as long as the enzyme maintains the activity. From the aspect of the general pH range of the food to be eaten, it is typically pH 3 to 10, preferably pH 5 to-8.

The method of the present invention may appropriately contain conventional processes such as a step of cutting meat, a step of mixing meat, and a step of adding other seasonings and additives.

The present invention also includes a method for modifying meat including a step of contacting meat with gluconate and protease.

The definition, contact amount, preferable range and the like of each component are as described above.

A prepared meat product produced by the method of the present invention is also included in the present invention.

Specifically, the prepared meat product of the present invention is a cooked product containing added gluconate in an amount of typically 0.001 to 5 g, preferably 0.005 to 2.5 g, more preferably 0.01 to 1 g, based on gluconic acid, and added protease in an amount corresponding to typically 0.1 to 500,000,000 U, preferably 0.5 to 250,000,000 U, more preferably 1 to 100,000,000 U, per 100 g of meat.

Specifically, the prepared meat product of the present invention is a cooked product containing added gluconate in an amount of typically 0.00001 to 5 g, preferably 0.0001 to 2.5 g, more preferably 0.0005 to 1 g, based on gluconic acid, and added protease in an amount corresponding to typically 0.1 to 500,000,000 U, preferably 0.5 to 250,000,000 U, more preferably 1 to 100,000,000 U, per 100 g of meat.

Other features of the invention will become apparent in the course of the following descriptions of exemplary embodiments which are given for illustration of the invention and are not intended to be limiting thereof.

### EXAMPLES

Unless otherwise specified, the sensory evaluation in this Example was performed using a sufficiently-trained expert panel who has been engaged in food business for not less than 5 years. In the present specification, % means % by weight unless otherwise specified.

### Example 1

### 1. Preparation Method of Sample

(1) Skin and fat were removed from the breast meat of commercially available domestic broiler chicken.
(2) The meat was formed into a 30 mm long×50 mm wide×5 mm thick cuboid (so that the side is parallel to the muscle fiber direction).
(3) Various materials shown in Table 1 were dissolved in a 0.3 M NaCl aqueous solution (salt concentration used for general meat processing; sodium chloride used was “Nakuru four 2” (manufactured by Naikai Salt Industries Co., Ltd.)) and used as sample solutions.
(4) The obtained sample solution was added to the reshaped chicken breast meat at 20%[w/w] based on the meat weight.
(5) This was vacuum packaged using a vacuum packaging machine “V-455G-1” (manufactured by TOSEI).
(6) The package was stored at 4° C. overnight (for 18 hr).
(7) The treated meat was stood at room temperature for 20 min and returned to ordinary temperature.
(8) Using a thermostatic tank “Thermal Robo TR-1AR” (manufactured by AS ONE), the meat was heated in water bath at 75° C. for 30 min.
(9) The heated sample was taken out from a vacuum pack and water on the surface was wiped off with a paper towel.
(10) The obtained boiled chicken breast meat was subjected to a sensory evaluation.

### 2. Sensory Evaluation

The sensory evaluation was performed by a panel of 5 experts for the tenderness of the meat center, juicy feeling (juicy feeling during chewing), and overall sensory quality.

No addition plot (test plot No. 1) was used as a control. The overall sensory quality means a state where both tenderness of meat center and juicy feeling are imparted.

The results of sensory evaluation are

“−”: no effect or opposite effect
“+”: effective
“++”: remarkably effective
“+++”: very remarkably effective.

The results are shown in the following Table 1.

TABLE 1

| | | | amount added | | sensory evaluation results | | |
|---|---|---|---|---|---|---|---|
| | | | | amount of | tenderness | | |
| test | | | amount added | enzyme added | of | | total |
| plot | | | [g] per 100 g | [U] per 100 g | meat | juicy | sensory |
| No. | category | test plot | of meat | of meat | center | feeling | quality |
| 1 | — | — | — | — | − | − | − |
| 2 | general | alkali (sodium | 0.24 | — | + | + | + |
| | meat | carbonate) | | | | | |
| 3 | processing | phosphate (sodium | 0.15 | — | + | + | + |
| | agent | polyphosphate) | | | | | |
| 4 | | potato starch | 0.12 | — | − | + | − |
| 6 | organic | sodium citrate | 0.085 | — | − | + | − |
| 7 | acid salt | calcium lactate | 0.10 | — | + | − | − |
| 8 | | monosodium fumarate | 0.16 | — | − | + | − |
| 9 | | sodium malate | 0.12 | — | − | + | − |
| 10 | | sodium gluconate | 0.10 | — | − | ++ | − |
| 11 | enzyme | protease (papain) | — | 840 | ++ | _ | − |
| 12 | combined | sodium gluconate × | sodium | 840 | +++ | +++ | +++ |
| | use | protease | gluconate 0.10 | | | | |

Meat processing agents of test plot Nos. 2 to 4 were made by reference to the general addition amount used for single-ingredient meat.

Organic acid salts of test plot Nos. 6 to 10 were added such that the same mol concentration was achieved at the time of immersion.

As protease of test plot Nos. 11 and 12, “papain W-40” (manufactured by Amano Enzyme Inc.) was used.

As shown in Table 1, the combination of sodium gluconate and protease imparted the tenderness and juicy feeling of the meat center and preferable quality was achieved. Particularly, a remarkable effect was observed by the combination than alkali and phosphate which are general meat processing agents.

### Example 2

### 1. Preparation Method of Sample

Samples were prepared by the same method as in Example 1.

### 2. Sensory Evaluation

An overall sensory evaluation was performed by a panel of experts according to the same standard as in Example 1. The results are shown in the following Table 2.

TABLE 2

| | | | amount added | | sensory evaluation results | | |
|---|---|---|---|---|---|---|---|
| test | | | amount of organic acid | amount of enzyme | tenderness | | overall |
| plot | | | salt added [g] per | [U] added per | of meat | juicy | sensory |
| No. | category | test plot | 100 g of meat | 100 g of meat | center | feeling | quality |
| 1A | — | — | — | — | − | − | − |
| 2A | enzyme | protease (papain) | — | 840 | ++ | − | − |
| 3A | combined | sodium citrate × | 0.0001 | | ++ | − | − |
| 4A | use | protease | 0.001 | | ++ | − | − |
| 5A | | | 0.01 | | ++ | + | + |
| 6A | | | 0.1 | | ++ | + | + |
| 7A | | | 1 | | ++ | − | − |
| 8A | | sodium gluconate × | 0.0001 | | ++ | + | + |
| 9A | | protease | 0.001 | | ++ | ++ | ++ |
| 10A | | | 0.01 | | +++ | +++ | +++ |
| 11A | | | 0.1 | | +++ | +++ | +++ |
| 12A | | | 1 | | ++ | ++ | ++ |

As protease of test plot Nos. 2A to 12A, “papain W-40” (manufactured by Amano Enzyme Inc.) was used.

As sodium citrate of test plot Nos. 3A to 7A, “purified sodium citrate” (manufactured by Fuso Chemical Co., Ltd.) was used.

As sodium gluconate of test plot Nos. 8A to 12A, “Herushasu A” (manufactured by Fuso Chemical Co., Ltd.) was used.

Sodium gluconate×protease imparted the tenderness and juicy feeling of the meat center, and remarkably preferable quality was achieved as compared to sodium citrate of organic acid salt (general food additive)×protease.

### Example 3

### 1. Preparation Method of Sample

Samples were prepared by a method similar to that in Example 1 except that various materials shown in Table 3 were used.

### 2. Sensory Evaluation

The overall sensory evaluation was performed by a panel of 5 experts according to the same standard as in Example 1. The results are shown in the following Table 3.

TABLE 3

| | | | amount added | | sensory evaluation results | | |
|---|---|---|---|---|---|---|---|
| test | | | amount of organic | amount of enzyme | tenderness | | total |
| plot | | | acid salt added [g] | added [U] per | of meat | juicy | sensory |
| No. | category | test plot | per 100 g of meat | 100 g of meat | center | feeling | quality |
| 1B | — | — | — | — | − | − | − |
| 2B | enzyme | protease (papain) | — | 840 | ++ | − | − |
| 3B | combined | sodium citrate × | 0.1 | | ++ | + | + |
| | use | protease | | | | | |
| 4B | | potassium citrate × | | | ++ | + | + |
| | | protease | | | | | |
| 5B | | calcium citrate × | | | ++ | − | − |
| | | protease | | | | | |
| 6B | | sodium gluconate × | | | +++ | +++ | +++ |
| | | protease | | | | | |
| 7B | | potassium gluconate × | | | +++ | +++ | +++ |
| | | protease | | | | | |
| 8B | | calcium gluconate × | | | ++ | ++ | ++ |
| | | protease | | | | | |

As protease of test plot Nos. 2B to 8B, “papain W-40” (manufactured by Amano Enzyme Inc.) was used.

As sodium/potassium/calcium citrate of test plot Nos. 3B to 5B, “purified sodium citrate”, “purified potassium citrate”, “calcium citrate” (manufactured by Fuso Chemical Co., Ltd.) were respectively used.

As sodium/potassium/calcium gluconate of test plot Nos. 6B to 8B, “Herushasu A”/“Herushasu K”/“calcium gluconate” (manufactured by Fuso Chemical Co., Ltd.) were respectively used.

Gluconate (sodium salt, potassium salt, calcium salt)×protease in combination with any salt imparted tenderness and juicy feeling up to the meat center, and afforded remarkably preferable quality.

Industrial Applicability According to the present invention, meat that does not lose umami or gravy of the meat even after heating and can afford a juicy and tender texture up to the meat center can be provided.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A composition for modifying meat, comprising at least one gluconate and at least one protease.

2. The composition according to claim 1, wherein said at least one protease is present in an amount of 100 to 100,000,000 U per 1 g of gluconic acid.

3. The composition according to claim 1, wherein said at least one gluconate is at least one member selected from the group consisting of sodium gluconate, potassium gluconate, and calcium gluconate.

4. A method for producing a prepared meat product, comprising contacting meat with at least one gluconate and at least one protease.

5. The method according to claim 4, comprising contacting said meat with 0.00001 to 5 g of said at least one gluconate, based on gluconic acid, per 100 g of the meat.

6. The method according to claim 4, comprising contacting said meat with 0.1 to 500,000,000 U of said at least one protease per 100 g of the meat.

7. A prepared meat product, comprising added gluconate and added protease, wherein said added gluconate is present in an amount of 0.001 to 5 g of gluconic acid, and said added protease is present in an amount of 0.1 to 500,000,000 U, each per 100 g of meat.

8. A method for modifying meat, comprising contacting the meat with at least one gluconate and at least one protease.
